(19) United States
(12) Patent Application Publication
(10) Pub. No.: US 2014/0244525 A1
(43) Pub. Date: Aug. 28, 2014

(54) ENTITLEMENT CARDS AND USER LICENSE REDEMPTION IN ONLINE SERVICES

(71) Applicant: MICROSOFT CORPORATION, Redmond, WA (US)

(72) Inventors: Jignesh Kacharia, Redmond, WA (US); Ron E. Critchfield, Woodinville, WA (US); Keerti Rane, Bellevue, WA (US); Albert Chik Shi Shen, Redmond, WA (US); Peter Richard Ricci, Seattle, WA (US); Paul Raymond Lenehan, Seattle, WA (US); Aliaksandr Bulankou, Redmond, WA (US); Michael Pierce, Seattle, WA (US); Tulasi Pratipati, Redmond, WA (US); Anand Doshi, Bellevue, WA (US); Prachi Subhash Jadhav, Seattle, WA (US); Rajesh Shanmukam, Bothell, WA (US)

(73) Assignee: MICROSOFT CORPORATION, Redmond, WA (US)

(21) Appl. No.: 13/777,983

(22) Filed: Feb. 26, 2013

(51) Int. Cl. G06Q 30/00

(52) U.S. Cl. CPC G06Q 30/018
USPC 705/317

(57) ABSTRACT

Entitlement cards having an offer term and number of user licenses for a subscription to an online service can be applied to existing subscriber accounts to add or otherwise adjust the number of user licenses associated with the subscription. When an entitlement card is added to an account, the system automatically adjusts the amount of time for each user license so that an entire value of an entitlement subscription is used and a same expiry date is maintained even when adding new user licenses to an existing account. A user interface is provided that enables a customer to change the number of user licenses for a subscription when redeeming an entitlement card to their account and view a new end date for the subscription as a whole resulting from a change in user licenses during a current subscription.

### BACKGROUND

Software as a service (SaaS) makes use of a cloud computing infrastructure to deliver one application to many users, regardless of their location, rather than the traditional model of one application per desktop. SaaS is a delivery model in which software is hosted on the cloud and accessed by clients through a browser. By deploying software as a hosted service and accessed over the internet, SaaS allows activities to be managed from central locations in a one-to-many model.

As software is moving from a perpetual license tied to a single machine or being “on premise” to online subscription services that are associated with a particular user or tenant, there becomes a need for infrastructure to support sales outside of online channels, license management, and purchase paradigms.

### BRIEF SUMMARY

Entitlement cards, systems for implementing entitlement cards, and methods of managing user licenses and their terms in an online service are described.

According to one aspect, an entitlement card for a subscription to an online service is provided that is sold in units of an offer term for a specified number of user licenses, such as a 1 year-1 user license. According to another aspect, the entitlement card is configured to enable its specified number of user licenses to be added to an existing subscription. According to another aspect, the entitlement card is configured to enable distribution of the offer term across existing user licenses of a subscription.

A system for redeeming entitlements can include an online portal to an online service that can receive one or more product keys from a customer's entitlement card(s) to update an existing subscription including an adjustment to a number of user licenses associated with the subscription. The online portal can request an end date calculation involving the distribution of offer term to create a single end date for the user licenses on the subscription and place an order for the updated subscription from an order management system.

According to an embodiment, the distribution of an offer term from an entitlement card for an online service subscription can be accomplished by calculating a new term from a date that a number of user licenses for a subscription is adjusted such that all user licenses for the subscription have a same end date. The new term and new end date can be obtained by multiplying a current user license count with the remaining number of days on the term for the current existing subscription, adding this number to the number of user licenses multiplied by the offer term of the entitlement card, and dividing this total by the total number of user licenses for the account after adjustment to obtain the new term. The new end date can be obtained by adding the new term to the date that the number of user licenses for the subscription is adjusted.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A shows a diagram of an operating environment in which certain embodiments may be carried out.

FIG. 1B shows an entitlement card online subscription system for an online service according to an embodiment.

FIG. 2 shows a user process flow of an entitlement card for online services according to an embodiment.

FIGS. 3A-3C show user interfaces for redeeming an entitlement card illustrating a user process flow according to an embodiment.

FIGS. 4A-4E illustrate subscription renewals for some example scenarios in which the entitlement cards for online services of certain embodiments may be used.

FIG. 5 shows a graphical representation of a mid-subscription addition of a new user license.

FIG. 6 shows a subscription management interface with self-serve subscription adjustment according to an embodiment.

FIG. 7 shows an entitlement card redemption process according to an embodiment.

FIG. 8 shows an end date calculation process for an entitlement card redemption process according to an embodiment.

FIG. 9 shows a sequence diagram for redeeming an entitlement card to update an existing subscription according to an embodiment.

FIG. 10 shows a block diagram illustrating components of a computing device used in some embodiments.

### DETAILED DESCRIPTION

Entitlement cards, systems for implementing entitlement cards, and methods of managing user licenses and terms in an online service are described.

Certain embodiments contemplate using entitlement cards through offline and online retailers to sell subscriptions for online services. The entitlement cards provide product keys for an entitlement. According to various embodiments, the entitlements to which the described entitlement cards are directed to involve subscriptions to an online service. In one embodiment, each entitlement card is redeemable for a 1 year subscription to the online service. Although a 1 year subscription is described, it should be understood that a different offer term may be implemented.

A customer can take the entitlement card having the product key and redeem the product from the online service to obtain or renew a subscription to the online service. Using the software as a service model, the online service subscription is associated with a user (or organization) account and not a device, package, or product key.

According to embodiments, multiple user licenses can be included on a same subscription—with their renewal dates tied together. By tying the renewal dates together, only one date is used as the expiration date, and extending the subscription for the multiple user licenses can be carried out at the same time. In addition to having multiple user licenses on a single subscription, embodiments enable adjustments to the number of user licenses within a subscription period. Embodiments are capable of adding (or adjusting) the number of user licenses to an existing subscription account, simplifying license management for a business, enterprise, or individual. In particular, adding a new user license to an existing subscription can be accomplished without creating multiple expiration/renewal dates to keep track of.

Entitlement cards of embodiments of the invention generally involve a substrate on which a product key is disposed. The substrate may be a card, box, paper or other physical implement on which a product key is readable. The product key may be human readable (by being printed or stamped) or machine readable (such as by magnetic strip or radio frequency transmission). In some cases a product key can be provided to a customer in a form that is not on a physical card or substrate. For example, the product key may be sent to a customer in a message, email, or by some other form of communication. The redemption of an entitlement card (and its product key) as described herein may be applicable to any form of conveying to a customer the product that they purchased and its corresponding product key to enable redemption of the online service.

As purchased, the entitlement card represents an offer term for a specified number of user licenses for a subscription to an online service. For example, an entitlement card may be a 1 year subscription for 1 user (a “1 year-1 user subscription”) to an online service. According to embodiments of the invention, the entitlement card, for example, the 1 year-1 user license subscription, can be applied to an account redeemable as units of time and distributable across a number of user licenses.

Although an entitlement card of certain embodiments may have a monetary value associated with it, the entitlement card of certain embodiments is not redeemable for money or points or other form of credit; is not used to store credit; and is not reloadable. Rather, the entitlement card for online services represents a subscription for a user license (or designated number of user licenses) for 1 year (or 365 days) or some other designated period of time. Possible offer terms include, but are not limited to, 1 month, 100 days, 1-6 months, 6 months, 7-12 months, 12-18 months, 1 year, 1-2 years, and 2 years.

Once the entitlement card is redeemed, the product key used by the system to validate the purchase of the entitlement card can be discarded because the subscription is attached to a customer identifier instead of the product key. In this manner, the entitlement card is packaging for a 1 year subscription to an online service that attaches to a customer and can be used by the customer anywhere the customer has access to a portal of the online service.

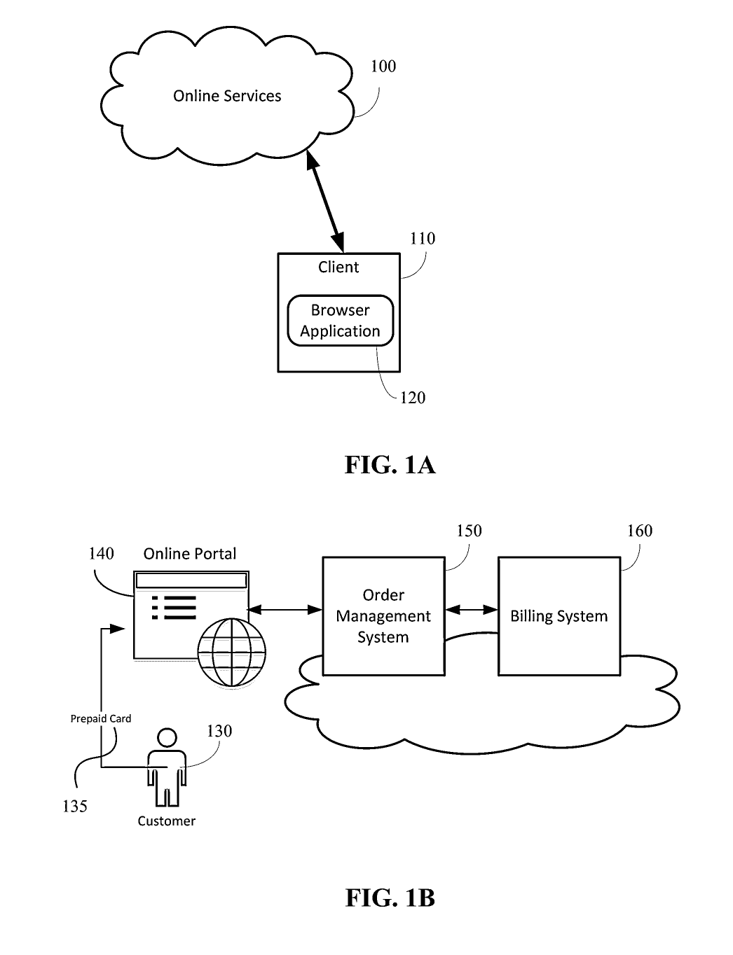

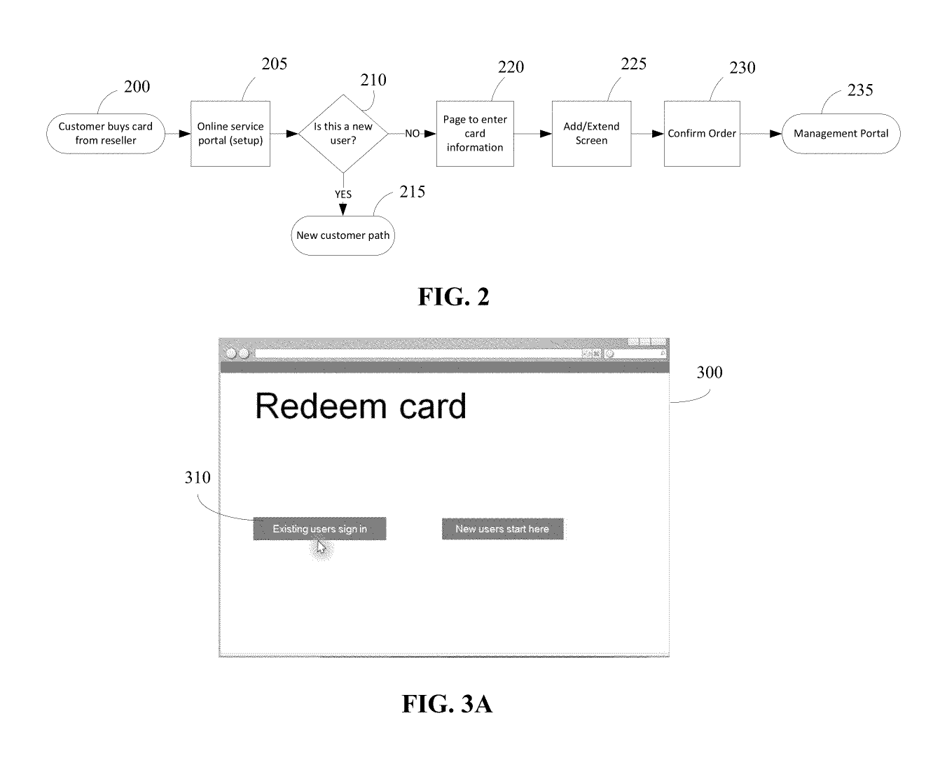

FIG. 1A shows a diagram of an operating environment in which certain embodiments may be carried out.

Referring to FIG. 1A, the operating environment can include one or more cloud or web services such as online services 100 that can be accessed by a client device 110 running a browser application 120. The browser application 120 is an application program for retrieving and traversing information resources on the World Wide Web (“the Web”), as well as resources provided by web servers in private networks, and presenting the information resources to a user (e.g., rendering for display). The user may access the cloud service through entering a uniform resource locator (URL) in the browser application 120, which can render the portal of the online services 100.

A cloud service generally refers to hosted services providing scalable processing and storage capabilities. Cloud computing may often include virtualized resources. The resources presented by cloud computing are in themselves provided as a service, where cloud computing customers rent usage of resources from a third-party provider that owns the physical infrastructure. A client organization that is served by a cloud service and shares resources controlled or managed by the cloud service with other client organizations can be referred to as a tenant.

Web services can be provided and/or hosted by a cloud service (e.g., as part of a large-scale distributed computing environment). A web service is a software system that supports interoperable machine-to-machine interaction over a network and enables software to connect to other software applications.

A web service provides a collection of technological standards and protocols. For example, a web service provides functions that may be implemented by a software or hardware agent that sends and receives messages (e.g., the computing platforms requesting and providing a particular service). Applications can access web services via ubiquitous web protocols and data formats such as hypertext transfer protocol (HTTP), XML, JavaScript Object Notation (JSON), Representational state transfer (REST) protocols, and SOAP (originally an acronym for simple object access protocol).

The cloud or web services, including online services 100 may be implemented using one or more physical and/or virtual servers communicating over a network. The network can include, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art.

The client device 110 can involve computing systems configured with one or more central processing units (CPUs), memory, mass storage, and I/O devices (e.g., network interface, user input device). Elements of a computing system can communicate with each other via a bus. In certain embodiments, the client device 110 can be embodied as a computing device including, but not limited to, a personal computer, a tablet, a reader, a mobile device, a personal digital assistant (PDA), a smartphone, a laptop (or notebook or netbook) computer, a gaming device or console, a desktop computer, or a smart television.

In addition, or as an alternative, to accessing software applications hosted on the cloud through a browser (e.g., browser application 120), some client devices 110 may access the software applications hosted on the cloud through an app (an application designed for mobile devices such as smartphones and tablets).

FIG. 1B shows an entitlement card online subscription system for an online service (such as online services 100) according to an embodiment. Referring to FIG. 1B, a customer 130 can purchase or receive an entitlement card (or other instrument providing the product key) and interact with a user interface 140 of an online portal (such as provided by browser application 120 running on client device 110) to redeem the entitlement card 135. An entitlement card can be purchased from a software and/or hardware reseller. The entitlement cards may be in the form of a 1 year-1 user license subscription to the online service. In some cases there may be cards available for a bundled number of user licenses for the 1 year subscription (e.g., 5 user licenses, 10 user licenses, 20 user licenses, 50 user licenses) that can be used in combination to arrive at a specified number of user licenses.

An entitlement card can be redeemed to create a new customer account, add user licenses to an existing subscription, or renew/extend an existing subscription. Once a product key from a first entitlement card is entered, additional user licenses can be added by entering another entitlement card's product key via the user interface 140.

At the backend (such as on the cloud), the system validates the purchase of the product (or entitlement) through an order management system 150, which interacts with a billing system 160 to tender the card (representing the entitlement). The billing system can check for whether the product key for the card being redeemed is valid, not already used, not blacklisted, stolen, or otherwise unavailable for redeeming.

When the customer enters their product key through the user interface 140, the order management system 150 receives the product key and passes card information to the billing system 160 in order to receive information as to the validity of the product key along with the user license count, offer, and account name (and other account information) it is associated with. The card information passed to the billing system 160 from the order management system 150 can include a product key. As the product key provided by each card is entered, the order management system 150 passes the information to the billing system to determine the validity of the product key and obtain a number of user licenses, offer, and account name from the billing system 160. Once the customer 130 indicates that the order is complete and confirms the order, the order management system 150 places an order to the billing system 160 to redeem the single card or batch of cards, marks any product keys from the cards as used, and provisions the services to the customer 130.

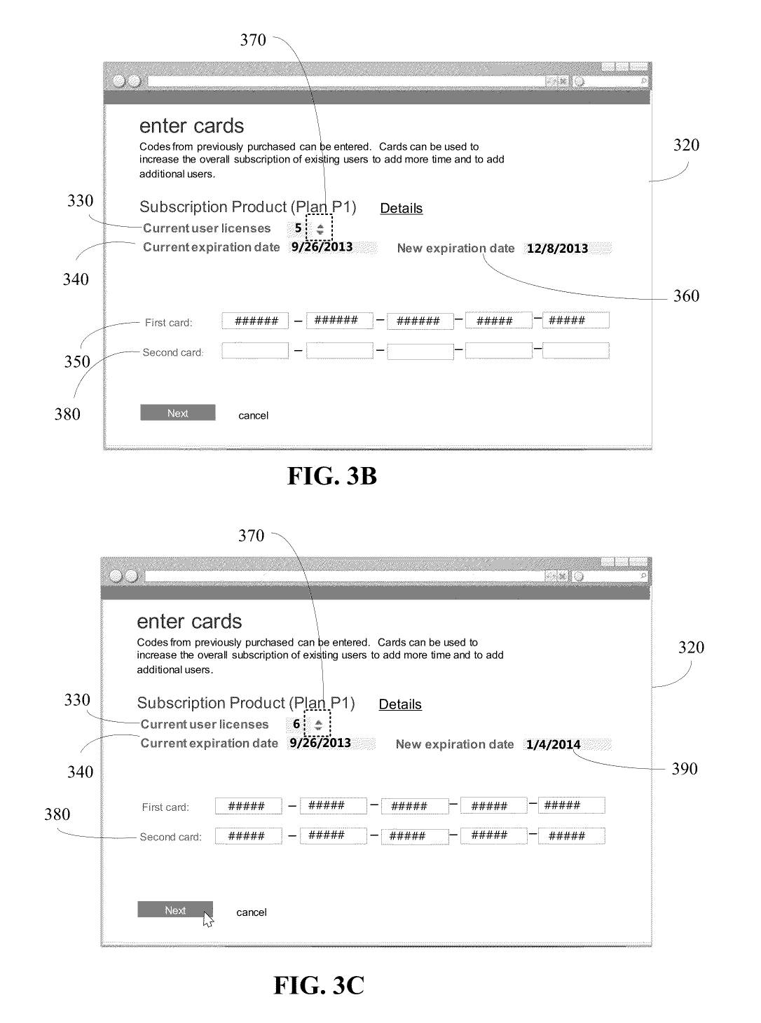

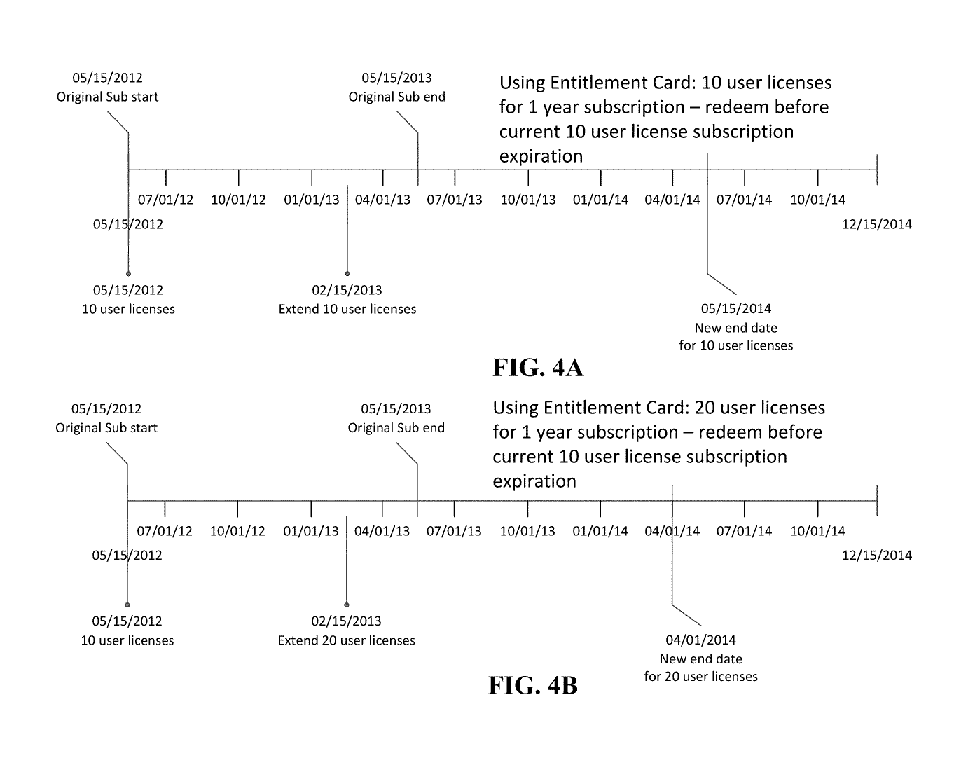

FIG. 2 shows a user process flow of an entitlement card for online services according to an embodiment; and FIGS. 3A-3C show user interfaces for redeeming an entitlement card illustrating a user process flow according to an embodiment.

Referring to FIG. 2, once a customer purchases the entitlement card (200), the customer can access an online service portal (205) for the product service to which the entitlement card is directed. From the portal, the customer can select to set up a new account or return to an existing account (210). If the customer is a new customer, a new customer path can be carried out to set-up the user licenses (215).

If the customer has an existing subscription, the customer can select to return to an existing account. For example, as shown in FIG. 3A, a portal interface 300 for redeeming an entitlement card may be rendered in a browser application window. A customer may elect to sign in as an existing customer by selecting the appropriate option on the screen (e.g., “Existing users sign in” 310).

Once the customer signs in, the customer can be directed to a page to enter card information (220). The card information can be a product key. From the page to enter card information, a customer can select to add user licenses, extend the license term, or do both (225).

The subscription updating (through adjusting number of users and extending the license term period) can be accomplished through the addition of each product key and the selection of increasing the number of user licenses or keeping the same number of user licenses so that the end date extends. In some cases, it is possible to reduce the number of user licenses and extend the subscription for the remaining user licenses. FIGS. 3B and 3C illustrate an example user interface 320 where a customer can enter product keys and adjust the subscription.

For example, referring to FIG. 3B, a customer having 5 current user licenses (330) and a current expiration date (340) of Sep. 26, 2013 may enter the product key from a 1 year-1 user license entitlement card into a first product key field (350). When the customer adds a product key from a card a “new expiration date” field (360) may pop up (with previous expiration date labeled as current expiration date).

Current user licenses (330) can have an arrow up/down button or adjustment slider (370) so that the user can adjust number of user licenses. Changing the number of user licenses will change the new expiration date.

Without an adjustment by the customer of the number of current user licenses 330 using the user adjustment slider 370 (shown as an up and down arrow in the figure), the use of the entitlement card (by entering its product key) automatically adjusts the expiration date so that all current user licenses are renewed to a same end date by even distribution of the 1 year time period across all user licenses.

In the example shown in FIG. 3B, the new expiration date (360) becomes Dec. 8, 2013, which is 73 days (365/5) from the current expiration date (340) of Sep. 26, 2013.

If the customer has another 1 year-1 user license entitlement card, the customer may select to add another card (not shown) and a second product key field (380) can appear on the interface to enable the customer to enter another product key. In other embodiments, the second product key field (380) may appear automatically after a product key is entered into the first card product key field (350) or a customer may indicate on a previous page the number of entitlement cards that are being redeemed and the appropriate number of product key fields may be provided.

Referring to FIG. 3C, the customer may choose to add another user license to the subscription. To indicate the desire for adding another user license, the customer may adjust the number of current user licenses (330) from 5 user licenses to 6 user licenses by using, for example, the user adjustment slider 370. Even though the customer has entered two 1 year-1 user license entitlement card product keys and added a new user license, the entitlement cards actually automatically adjust the expiration date so that all current user licenses expire at the same time. For example, if the customer adds the new user license on May 15, 2013, then the addition of the entitlements from the two entitlement cards results in a new expiration date for all 6 user licenses as Jan. 4, 2014 (360) due to the aggregation and distribution of the entitled user license/time.

Returning to FIG. 2, once the changes to the subscription order are confirmed (230), the information is provided to the management portal (235).

As an illustrative example, a company, CompanyABC, buys an entitlement card for an entitlement of a year subscription for 10 user licenses beginning January 1 and ending on December 31 of that year. On March 31, CompanayABC hires 2 more people. In the normal course of managing subscriptions, Company ABC obtains and enters 2 new keys for subscriptions that start April 1 and end March 31 of the following year. However, this approach can be confusing for the customer who now has to remember the dates to renew their 10 user licenses before January 1 and also the 2 user licenses before March 31 of the following year. According to embodiments, a system is provided in which the user licenses for the 2 new people can be added to the same subscription as the original 10 user licenses.

CompanyABC may obtain an entitlement card (as opposed to a credit card or monthly payment option) with a value of 1 year-1 user license for each person (e.g., 2 entitlement cards for the 2 people in this example). According to an embodiment, CompanyABC does not have to determine how to renew the subscriptions—such as ending all 12 user licenses in the subscription on December 31, which results in less time for (for the same cost) for the 2 userlicenses added on April 1, or adding 12 user licenses on March 31, which results in a lot more time (and cost) for the 10 user licenses they added January 1. Instead, certain embodiments automatically distribute the entitled time so that the end dates equalize and all user licenses are on the same subscription with a single end date.

Through the aggregation and distribution of the entitled user license/time, embodiments provide a customer, such as Company ABC, the full value of the new user licenses they added using the new cards on April 1 while setting the end dates to be consistent with the earlier ending subscriptions.

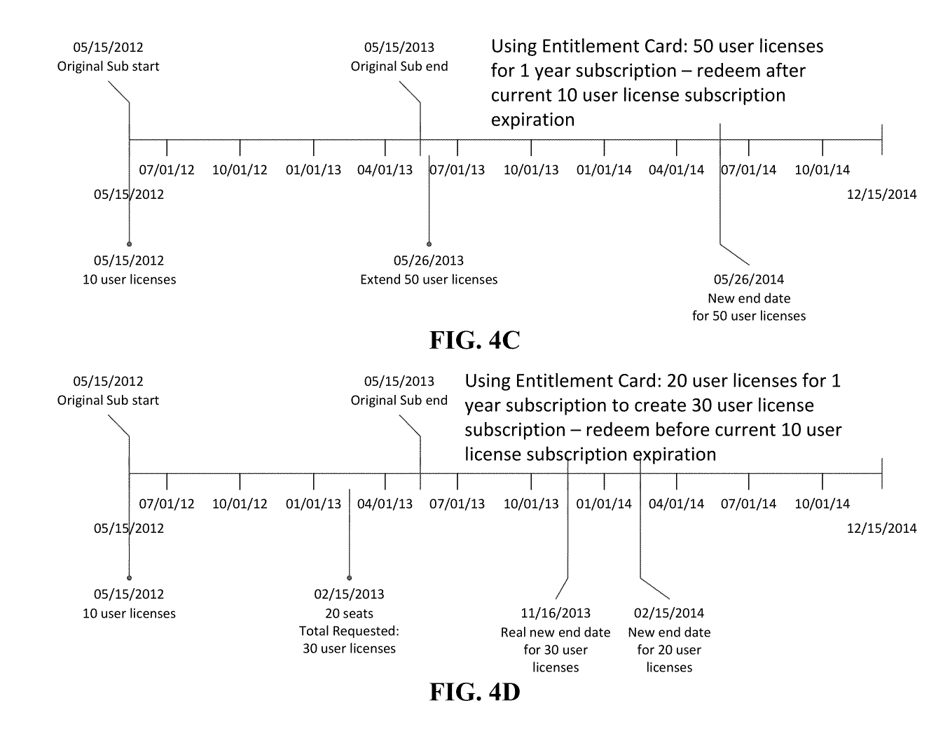

FIGS. 4A-4E illustrate subscription renewals for some example scenarios in which the entitlement cards for online services of certain embodiments may be used.

FIG. 4A shows a timeline in which an entitlement card is used to extend/renew subscription with an exact user license count before expiry. The original entitlement card subscription was 10 user licenses with a time period from May 15, 2012-May 15, 2013. If the administrator redeems an entitlement card on Feb. 15, 2013 with an exact user license count (the number of user licenses of the card match the number of user licenses in the subscription) and the intention to renew the subscription, the new end date becomes May 15, 2014 with a 10 user license count.

FIG. 4B shows a timeline in which an entitlement card is used to extend/renew a subscription along with adding a new user license count before the expiry. The original entitlement card subscription was 10 user licenses with a time period from May 15, 2012-May 15, 2013. If the administrator redeems an entitlement card on Feb. 15, 2013 with a user license count of 20 user licenses in order to add 10 user licenses, the new end date becomes Apr. 1, 2014 with the 20 user license count. This new end date is determined by calculating current user license days remaining=10*90=900 and new user license days=20*365=7300, which gives the total available user license days=8200. Then this total is divided by the new user license count=20 to provide the number of days available from the new entitlement card subscription applied evenly across all 20 user licenses, which is 410. Thus, the new end date is Apr. 1, 2014 with a 20 user license count.

FIG. 4C shows a timeline in which an entitlement card is used to extend/renew a subscription along with adding a new user license count after expiry. The original entitlement card subscription was 10 user licenses with a time period from May 15, 2012-May 15, 2013. If the administrator redeems an entitlement card on May 26, 2013, which is after the expiration of the subscription for the 10 user licenses, for an increased number of user licenses (e.g., 50 in this example), the calculations can follow the same process as described with respect to FIG. 4B. For example: the current available user license days=0 and the new user license days=50*365=18250, resulting in total user license days available as 18250. With a new user license count=50, the number of new user license days for each user license can be 365, resulting in a new end date of May 26, 2014 for the 50 user licenses. However, a simplified view of this scenario is that the administrator purchased a subscription for the 50 user licenses as if it was a new subscription starting at May 26, 2013, resulting in an end date of May 26, 2014.

FIG. 4D shows a timeline in which an entitlement card is used to add a new user license count. The original entitlement card subscription was 10 user licenses with a time period from May 15, 2012-May 15, 2013. On Feb. 15, 2013, the administrator adds 20 new user licenses using an entitlement card with 20 user licenses. Instead of having two separate end dates (May 15, 2013 for the first 10 user licenses and Feb. 15, 2014 for the newly added 20 user licenses), all 30 user licenses can receive the same end date. The new end date for the 30 user licenses becomes Nov. 15, 2013. This new end date is determined by calculating current user license days remaining=10*3*30=900 and new user license days available on the entitlement card=20*365=7300, which gives the total available user license days=8200. Then this total is divided by the total number of user licenses being requested (10+20=30) to provide the number of days available from the new entitlement card subscription, which is the number of days available with new total user license count=8200/30=274 days (rounded up) from Feb. 15, 2013 (which is=Nov. 16, 2013 instead of Feb. 15, 2014).

FIG. 4E shows a timeline in which an entitlement card is used to adjust a subscription with a user license count different from existing and new number of user licenses. The original entitlement card subscription was 10 user licenses with a time period from May 15, 2012-May 15, 2013. On Feb. 15, 2013, the administrator redeems an entitlement card for 20 user licenses. However, embodiments enable the administrator to request a different number of total user licenses instead of 30 (or 10 or 20 as previously described). For example, the administrator may desire a total of 15 user licenses. The expected end date for the 20 user licenses would be Feb. 15, 2014; however, the user desires only 15 user licenses, which is less than the 20 purchased with the entitlement card. Moreover, the original subscription for 10 user licenses as not yet ended. Therefore, the new end date is determined by calculating the number of days available (10*90=900 days remaining and 20*365=7300 with new total user license count=8200/15=547 days (rounded up) from Feb. 15, 2013, resulting in a new end date for 15 user licenses=Aug. 16, 2014 instead of Feb. 15, 2014.

As illustrated by the above examples, each card provides customers with 12 months of service from the date the cards are redeemed. Since existing user licenses have an early renewal date, the two end dates are averaged using, for example, the calculation [A (initial user licenses)×B (time remaining on subscription)+C (entitled number of user licenses)×(12 months)]÷total number of user licenses=new time remaining]. This can make it easier to manage multiple subscriptions with a single end date for all user licenses on a subscription account.

According to various embodiments, the first time that an entitlement card is redeemed by a customer, the entitlement card functions at face value. That is, the customer may receive an offer term and number of user licenses to the online service. However, the entitlement card is configured to function as a purchase of (#licenses)*(offer term) units of time for subscribing to the online service. That is, an entitlement to a period of time can be transformed into a number of user licenses and a number of userlicenses can be transformed into additional time. The number of user licenses transform into the additional time by reallocating their remaining time to other user licenses.

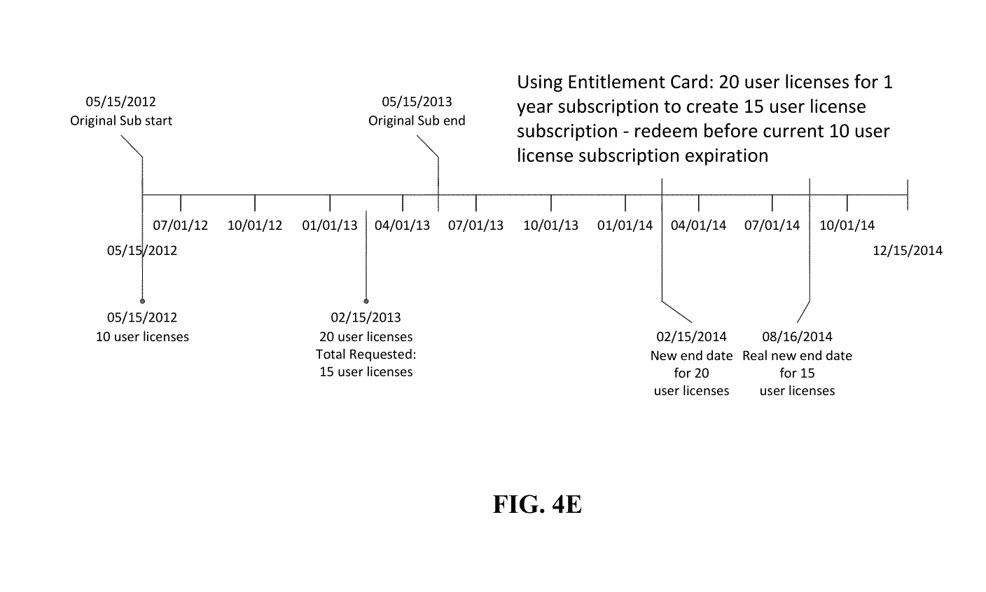

FIG. 5 shows a graphical representation of a mid-subscription addition of a new user license. If entitlement cards are added to an existing subscription, the end date will be extended. However, as shown in FIG. 5, according to embodiments of the invention, if a user license is added midterm to an existing one year account subscription using an entitlement card, the end date is adjusted so that all user licenses have same end date, extending the subscription end date of the earlier subscription using time from the 1 year subscription of the second entitlement card to balance the end date. Where the subscription account has one user license and the entitlement card is used to add a second user license two months into the first user license's service subscription, the system extends the subscription date of the first user license on the account by one month and reduces the number of months for the second user license by one month to balance the end date while retaining a total number of months of service=24 months for the account.

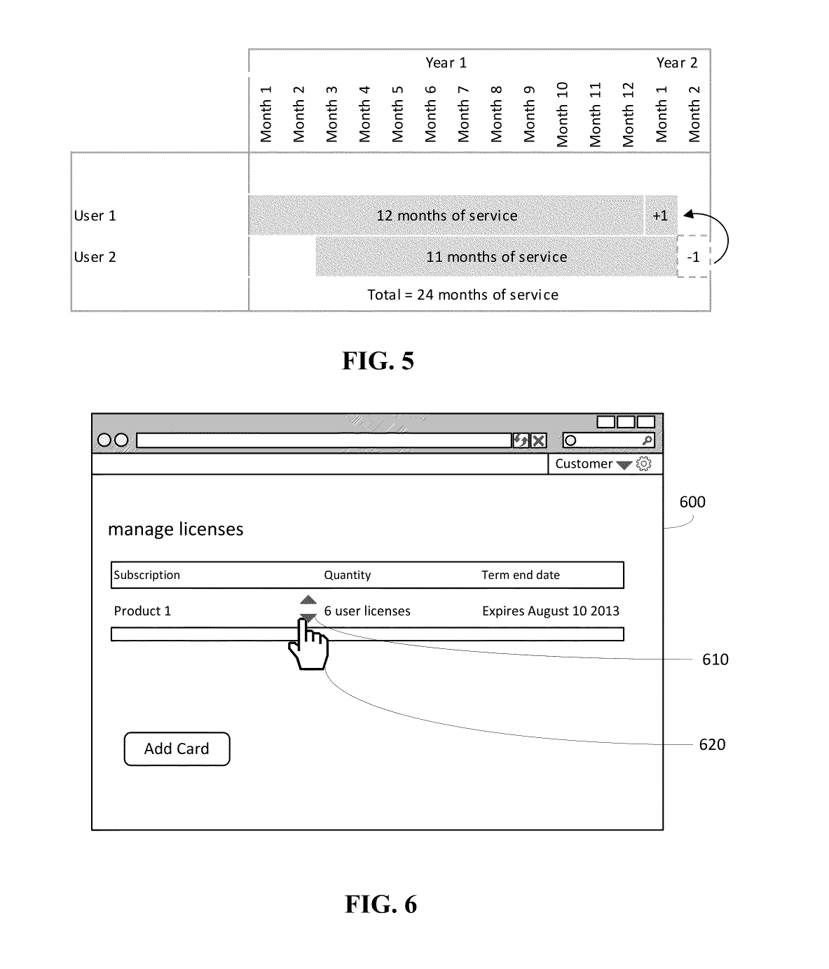

In some embodiments, a customer may change the number of user licenses and subscription term through a subscription management interface separate from adding a new entitlement card (or being on the screen for redeeming an entitlement card). FIG. 6 shows a subscription management interface with self-serve subscription adjustment according to an embodiment. Referring to FIG. 6, in addition, or as an alternative, to having a self-serve subscription adjustment on the page where a customer enters an entitlement card program key (such as shown in FIGS. 3B and 3C), a subscription management interface 600 for the online portal can be used to adjust the number of user licenses on the subscription. To adjust the number of user licenses, an adjustment slider 610 may be incorporated on the page. When the number of user licenses is adjusted by clicking or tapping (620) the adjustment slider 610 (or providing some other input command, voice control or gesture), the end date can automatically update to distribute the remaining number of days on the subscription.

In one scenario, the subscription management interface with user adjustment slider can benefit a customer that makes a mistake while adding user licenses on the entitlement card redemption page. In another scenario, the subscription management interface can enable a customer to adjust a subscription based on the needs of their business, for example, when they want to reduce the number of user licenses or briefly increase the number of user licenses.

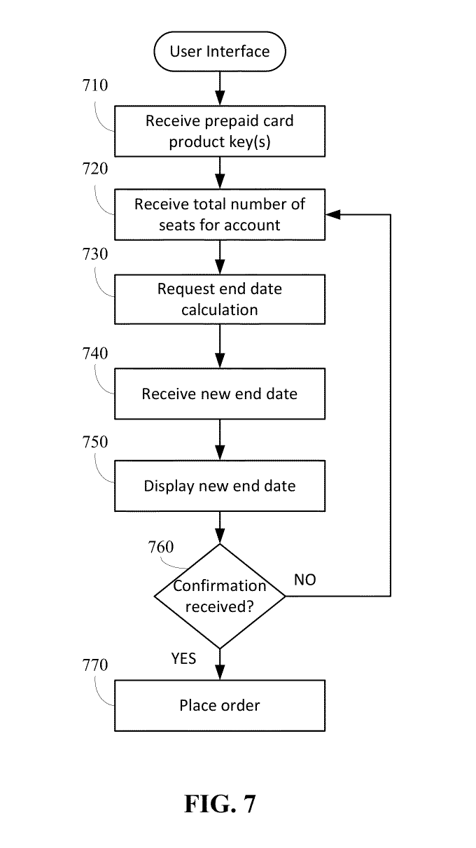

FIG. 7 shows an entitlement card redemption process according to an embodiment. An online portal user interface can receive one or more entitlement card product keys for an existing account (710), and a total number of user licenses for the account (720). The total number of user licenses may be more, fewer, or the same number of user licenses as existing in the subscription for the account. The online portal can request (730) an end date calculation for the subscription due to the addition of the product key(s) and the adjustment (if any) to the number of user licenses for the account. After receiving a new end date (740), the new end date can be displayed in the user interface (750). The confirmation state is determined (760) and when confirmation is received, the online portal can place the order for the extended subscription (770). The user license count may be adjusted (720) while the customer is within the user interface of the online portal and new end dates requested (730), received (740), and displayed (750) until confirmation is received (760) to place the order (770).

On the front end, an entitlement card is sold as, and provides, an offer term subscription for a specified number of user licenses, such as a 1 year-1 user license subscription. On the back end, the offer term for the specified number of user licenses can be aggregated for multiple user licenses, providing flexibility to assign time to any number of people so long as they are all under the same subscription and expire on the same date. The allocation of time to create a same expiry date is automatic. This can help manage multi-user license subscriptions.

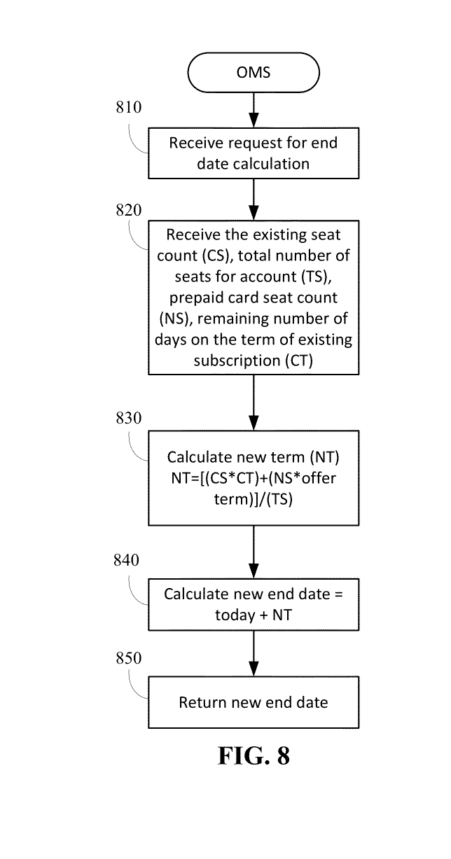

FIG. 8 shows an end date calculation process for an entitlement card redemption process according to an embodiment. Referring to FIG. 8, an order management system (OMS) can receive the request for end date calculation (810), for example from the online portal, and receive the existing and total number of user licenses for the account (which may be the same, more, or fewer than existing on the account), the number of user licenses for the offer term from the entitlement card(s), and the remaining number of days on the term of existing subscription (820). By using this information, the order management system can calculate the new term for the subscription (830) and calculate the new end date for the subscription (840). The new term for the subscription can be calculated (830) as NT=[(CS*CT)+(NS*offer term)]/(TS), where CS is the current (existing) number of user licenses for the account, CT is the number of days remaining on the term of existing subscription, NS is the number of user licenses for the offer term from the entitlement card, the offer term is the subscription period for the entitlement card (such as 1 year), and TS is the total number of user licenses for the account (as possibly modified by the customer).

The new end date can be rounded up to the next full day. In addition, some end date constraints may be implemented based on business considerations. For example, a limit may be placed on how long of a term the subscription can be (for example, 40 years of a subscription may be too long). In some cases a restriction may be in place to not allow an end date to be less than a current end date. In some cases a restriction may be in place to not allow an end date to fall on certain days of the year or certain days of a month.

The new end date can be calculated (840) by adding the new term to the date that a customer is redeeming the entitlement card (or cards). Once calculated, the new end date can be returned to the online portal (850).

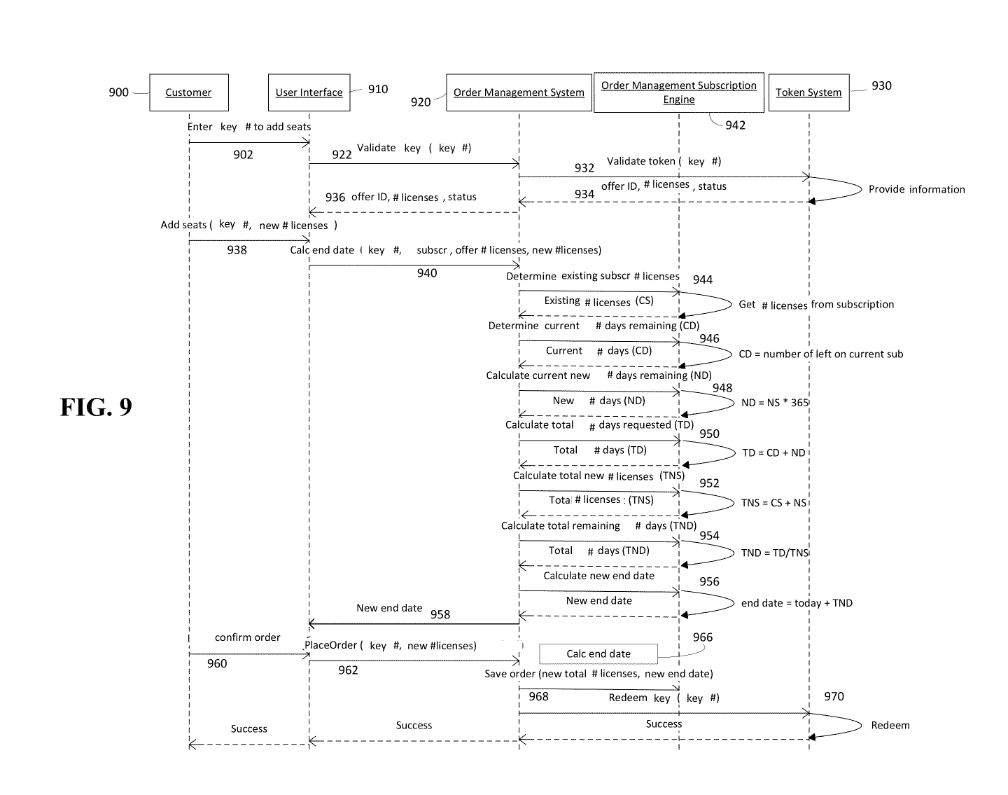

FIG. 9 shows a sequence diagram for redeeming an entitlement card to update an existing subscription according to an embodiment.

As shown in FIG. 9, it is possible to add more user licenses on the same subscription by using additional entitlement cards. The sequence flow can begin when a customer (900) enters a product key (902) via a user interface (910) of an online portal. When the customer (900) tries to add more user licenses using an entitlement card, an order management system (920) can be used to update the customer's existing account.

For example, the online portal passes the product key to the order management system (920) to validate (922) the product key, and the order management system (920) passes the product key to a billing system (930) to validate (932) the product key. The billing system (930) can provide information (934) of the offer, number of user licenses, and status (whether the product key is valid/invalid) to the order management system (920), which then returns the information (936) to the online portal to enable the customer to continue.

The customer (900) can add user licenses (938) via the user interface (910). When the customer adds (or modifies) the number of user licenses for the account, the online portal can, if the status for the product keys indicate the keys are valid, request a new end date (940) by passing the product key (with entitlement card's indicated number of user licenses), the subscription to which the keys are to be added, and the customer-adjusted number of user licenses to the order management system (920).

The order management system (920) uses an order management subscription engine (942) to determine existing subscription number of user licenses (944) by getting the current number of user licenses associated with the account, determine current number of days remaining on current subscription (946), calculate current new number of days remaining (new number of user licenses*365) (948), calculate total number of days requested (current number of days+new number of days) (950), calculate total number of user licenses (existing number of user licenses+new number of user licenses) (952), calculate remaining days (total days divided by total number of user licenses) (954), and calculate the new end date (today+total number of days) (956).

Once the calculations are performed, the new end date is returned to the online portal (958) for displaying to the customer via the user interface. The customer can confirm the order (960) and the online portal can place the order (962) for the customer by passing the product key (with entitlement card's indicated number of user licenses) and number of user licenses to the order management system (920). The order management system (920) can perform the new end date calculations (966), such as described with respect to steps 944, 946, 948, 950, 952, 954, and 956, and save the order (968). At this point the product key is redeemed to update the subscription (970).

According to certain embodiments, advantageously, the new end date result can be displayed without the product key being redeemed. That is, the end date and number of user licenses can be provided to the customer and adjusted by the customer without redeeming the product key or requiring the billing system to handle recalls to the redemption of the product key.

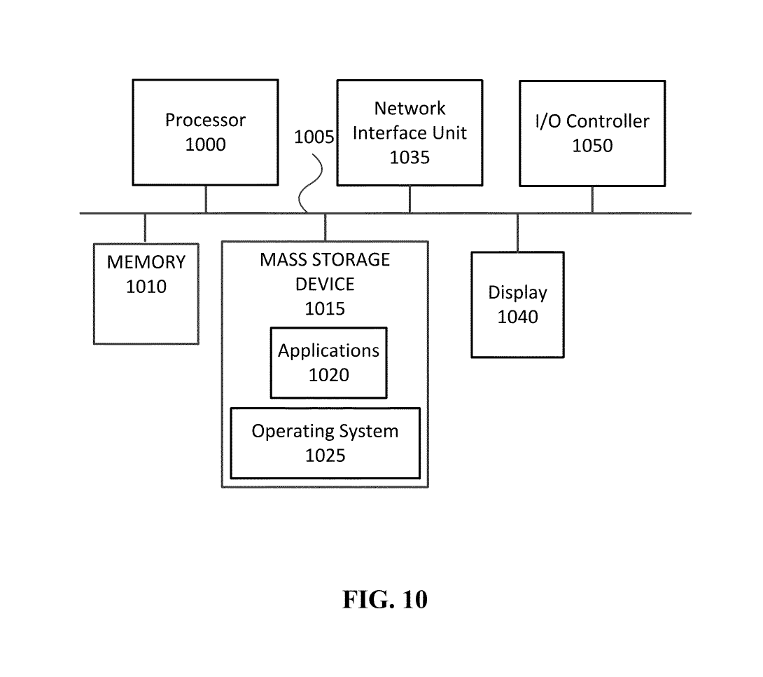

FIG. 10 shows a block diagram illustrating components of a computing device used in some embodiments. It should be understood that aspects of the system described herein are applicable to both mobile and traditional desktop computers, as well as server computers and other computer systems.

Referring to FIG. 10, a computing device can include a processor 1000 connected to components via a system bus 1005; a system memory 1010 and a mass storage device 1015. The processor 1000 processes data according to instructions of one or more application programs 1020, and/or operating system 1025. The processor 1000 may be, or is included in, a system-on-chip (SoC) along with one or more other components such as sensors (e.g., magnetometer, an ambient light sensor, a proximity sensor, an accelerometer, a gyroscope, a Global Positioning System sensor, temperature sensor, shock sensor) and/or network connectivity components (e.g., including network interface 1035).

The one or more application programs 1020 may be loaded into the mass storage device 1015 and run on or in association with the operating system 1025. Examples of application programs include phone dialer programs, e-mail programs, PIM programs, word processing programs, spreadsheet programs, Internet browser programs, messaging programs, game programs, and the like. Other application programs may be loaded into the mass storage device 1015 and run on the device, including various client and server applications.

It can be understood that the mass storage device 1015 may involve one or more memory components including integrated and removable memory components and that one or more of the memory components can store an operating system. According to various embodiments, the operating system includes, but is not limited to, SYMBIAN OS from Symbian Ltd., WINDOWS MOBILE OS from Microsoft Corporation, WINDOWS PHONE OS from Microsoft Corporation, WINDOWS from Microsoft Corporation, PALM WEBOS from Hewlett-Packard Company, BLACKBERRY OS from Research In Motion Limited, APPLE IOS from Apple Inc., and GOOGLE ANDROID OS from Google Inc. Other operating systems are contemplated.

The system memory 1010 may include a random access memory (“RAM”) and/or a read-only memory (“ROM”). The RAM generally provides a local storage and/or cache during processor operations and the ROM generally stores the basic routines that help to transfer information between elements within the computer architecture such as during startup.

A synchronization application may also be included and reside as part of the application programs 1020 for interacting with a corresponding synchronization application on a host computer system (such as a server) to keep the information stored in a non-volatile storage (such as of mass storage device 1015) synchronized with corresponding information stored at the host computer system.

The network interface 1035 allows the system to communicate with other computing devices, including server computing devices and other client devices, over a network. The network interface 1035 can include a unit to perform the function of transmitting and receiving radio frequency communications to facilitate wireless connectivity between the system and the “outside world,” via a communications carrier or service provider. Transmissions to and from the network interface 1035 are conducted under control of the operating system 1025, which disseminates communications received by the network interface 1035 to application programs 1020 and vice versa.

Visual output can be provided via a display 1040. The display may be a touch screen display. A touchscreen (which may be associated with the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

In other embodiments, a touch pad may be incorporated on a surface of the computing device that does not include the display. For example, the computing device may have a touchscreen incorporated on top of the display and a touch pad on a surface opposite the display.

The computer architecture also may include an input/output controller 1050 for receiving and processing input from a number of other devices, including a keyboard, mouse, electronic stylus, or microphone. Similarly, the input/output controller 1050 may provide output to a display screen (such as display 1040, a printer, speakers, or other type of output device).

In some embodiments, the display and the keypad are combined. In some embodiments two or more input/output (I/O) components including an audio interface and a video interface may be combined. Discrete processors may be included with the I/O components or processing functionality may be built-in to the processor 1000.

It should be understood that any mobile or desktop computing device implementing system described with respect to FIG. 10 may have more or fewer features or functionality than described and is not limited to the configurations described herein.

For example, in some embodiments, user interfaces and information of various types may be displayed and interacted with on a wall surface onto which user interfaces and information of various types are projected.

In various implementations, data/information stored via the system may include data caches stored locally on the device or the data may be stored on any number of storage media that may be accessed by the device via the network interface 1035 or via a wired connection between the device and a separate computing device associated with the device, for example, a server computer in a distributed computing network, such as the Internet. As should be appreciated such data/information may be accessed through the device via the network interface 1035 or a distributed computing network. Similarly, such data/information may be readily transferred between computing devices for storage and use according to well-known data/information transfer and storage means, including electronic mail and collaborative data/information sharing systems.

Certain techniques set forth herein may be described in the general context of computer-executable instructions, such as program modules, executed by one or more computing devices. Generally, program modules include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as code and/or data, which may be stored on one or more computer-readable media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

Computer-readable media can be any available computer-readable storage media or communication media that can be accessed by the computer system.

Communication media include the media by which a communication signal containing, for example, computer-readable instructions, data structures, program modules, or other data, is transmitted from one system to another system. The communication media can include guided transmission media, such as cables and wires (e.g., fiber optic, coaxial, and the like), and wireless (unguided transmission) media, such as acoustic, electromagnetic, RF, microwave and infrared, that can propagate energy waves. Computer-readable instructions, data structures, program modules, or other data can be embodied as a modulated data signal in, for example, a wireless medium such as a carrier wave or similar mechanism such as employed as part of a spread spectrum technique. The term “modulated data signal” refers to a signal that has one or more of its characteristics changed or set in a manner as to encode information in the signal. The modulation may be analog, digital or a mixed modulation technique. Communication media, particularly carrier waves and other propagating signals that may contain data usable by a computer system, are not included as computer-readable storage media.

By way of example, and not limitation, computer-readable storage media may include volatile and non-volatile, removable and non-removable media implemented in any method or technology for storage of information such as computer-readable instructions, data structures, program modules or other data. For example, a computer-readable storage medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data for use by a computer system. “Computer-readable storage media” do not consist of carrier waves or propagating signals.

In addition, the methods and processes described herein can be implemented in hardware modules. For example, the hardware modules can include, but are not limited to, application-specific integrated circuit (ASIC) chips, field programmable gate arrays (FPGAs), and other programmable logic devices now known or later developed. When the hardware modules are activated, the hardware modules perform the methods and processes included within the hardware modules.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. An entitlement card for online services configured with a product key for an offer term of a subscription to add a unit of user licenses, wherein the product key is redeemable as units of time distributable over existing user licenses in a subscription for which the product key is being redeemed, wherein the distribution of the units of time create a single end date for the subscription.

2. The entitlement card according to claim 1, wherein the offer term is a one year term and the unit of user licenses is for one user license.

3. The entitlement card according to claim 1, wherein the offer term is a one year term and the unit of user licenses is for 5, 10, 20 or 50 user licenses.

4. The entitlement card according to claim 1, wherein the subscription is not associated with the product key after the entitlement card is redeemed.

5. A computer-implemented method for redeeming entitlements to online services, comprising:
receiving one or more entitlement card product keys for updating an existing subscription to an online service including an adjustment to a number of user licenses associated with the subscription, wherein each entitlement card designates an offer term and a unit of user licenses; and
automatically adjusting an end date of the subscription such that the subscription has a single end date for the user licenses associated with the subscription.

6. The method according to claim 5, wherein automatically adjusting the end date of the subscription comprises:
distributing time from the offer term to create the single end date for the user licenses associated with the subscription.

7. The method according to claim 5, further comprising:
wherein the adjustment to the number of user licenses comprises a number of additional user licenses equal to the number of user licenses of the unit of user licenses.

8. The method according to claim 5, further comprising:
wherein the adjustment to the number of user licenses comprises a number of additional user licenses less than the number of user licenses of the unit of user licenses.

9. The method according to claim 5, further comprising:
converting time from the offer term, time from the existing subscription, or both into an additional user license of the subscription to perform the adjustment to the number of user licenses associated with the subscription.

10. The method according to claim 5, further comprising:
converting a user license of the subscription into additional time for the subscription, extending the end date.

11. The method according to claim 5, wherein automatically adjusting an end date of the subscription such that the subscription has a single end date for the user licenses associated with the subscription comprises:
requesting an end date calculation from an order management system.

12. The method according to claim 11, wherein the end date calculation comprises:
multiplying a current user license count with a remaining number of days for the existing subscription to obtain a first value;
multiplying the offer term times a number of user licenses in the unit of user licenses of the entitlement card to obtain a second value;
adding the first value and the second value to obtain a third value;
dividing the third value by the number of user licenses associated with the subscription after the adjustment to obtain a new term; and
adding the new term to the to the date that the number of user licenses associated with the subscription is adjusted to obtain the end date.

13. The method according to claim 5, wherein the subscription is not associated with the one or more entitlement card product keys received to update the existing subscription.

14. One or more computer-readable storage media comprising instructions that, when executed, cause a system to:
provide a user interface of a portal of an online service for redeeming an entitlement card; and
in response to receiving one or more entitlement card product keys for updating an existing subscription for the online service including an adjustment to a number of user licenses associated with the subscription, automatically adjust an end date of the subscription such that the subscription has a single end date for the user licenses associated with the subscription,
wherein each entitlement card designates an offer term and a unit of user licenses.

15. The media according to claim 14, further comprising instructions that, when executed, cause the system to:
provide an adjustment slider to receive the adjustment to the number of user licenses associated with the subscription.

16. The media according to claim 15, wherein the adjustment slider is provided on a same page as an interface to receive the one or more entitlement card product keys.

17. The media according to claim 14 wherein the end date is adjusted so that a total amount of time of an entire term of the existing subscription and the offer term is the same while the single end date is after the end date of the existing subscription.

18. The media according to claim 14, further comprising instructions that, when executed, cause the system to:
in response to the adjustment to the number of user licenses, convert time from the offer term, time from the existing subscription, or both into an additional user license of the subscription to perform the adjustment to the number of user licenses associated with the subscription.

19. The media according to claim 14, further comprising instructions that, when executed, cause the system to:
in response to the adjustment to the number of user licenses, convert a user license of the subscription into additional time for the subscription, extending the end date.

20. The media according to claim 19, further comprising instructions that, when executed, cause the system to:
calculate an end date by:
multiplying a current user license count with a remaining number of days for the existing subscription to obtain a first value;
multiplying the offer term times a number of user licenses in the unit of user licenses of the entitlement card to obtain a second value;
adding the first value and the second value to obtain a third value;
dividing the third value by the number of user licenses associated with the subscription after the adjustment to obtain a new term; and
adding the new term to the to the date that the number of user licenses associated with the subscription is adjusted to obtain the end date.
